(19) United States
(12) Patent Application Publication
(10) Pub. No.: US 2002/0008723 A1
(43) Pub. Date: Jan. 24, 2002

(54) PRINTER AND METHOD OF COMPENSATING FOR MALPERFORMING AND INOPERATIVE INK NOZZLES IN A PRINT HEAD

(76) Inventors: XIN WEN, ROCHESTER, NY (US); LAM J EWELL, ROCHESTER, NY (US); DOUGLAS W COUWENHOVEN, FAIRPORT, NY (US); EDWARD A HAUSCHILD, PITTSFORD, NY (US)

Correspondence Address: PATENT LEGAL STAFF, EASTMAN KODAK COMPANY, 343 STATE STREET, ROCHESTER, NY, 14650-2201, US

(21) Appl. No.: 09/193,348

(22) Filed: Nov. 17, 1998

Related U.S. Application Data
(63) Continuation-in-part of application No. 09/119,909, filed on Jul. 21, 1998, now abandoned.

(51) Int. Cl. B41J 29/393

(52) U.S. Cl. 347/19

(57) ABSTRACT

Printer and method of compensating for inoperative nozzles in a print head. The printer comprises a print head and a plurality of nozzles formed in the print head. At least one of the nozzles may be inoperative and at least another one of the nozzles is operative. A detection system is coupled to the nozzles for detecting the inoperative nozzle. A computer is connected to the detection system for re-assigning printing function of the inoperative nozzle to the operative nozzle, so that a suitable output image is printed although some nozzles are inoperative.

### CROSS REFERENCE TO RELATED APPLICATIONS

This is a continuation-in-part of application Ser. No. 09/119,909, filed Jul. 21, 1998, entitled “Printer And Method Of Compensating For Inoperative Ink Nozzles In A Print Head” by Xin Wen, Lam J. Ewell, Douglas Couwenhoven and Edward Hauschild.

### BACKGROUND OF THE INVENTION

This invention generally relates to ink jet printer apparatus and methods and more particularly relates to an ink jet printer and method of compensating for malperforming or inoperative ink nozzles in a print head, so that high quality images are printed although some ink nozzles are malperforming or inoperative.

An ink jet printer produces images on a receiver by ejecting ink droplets onto the receiver in an imagewise fashion. The advantages of non-impact, low-noise, low energy use, and low cost operation in addition to the capability of the printer to print on plain paper are largely responsible for the wide acceptance of ink jet printers in the marketplace.

It is known that quality printing by an ink jet printer requires repeated ejection of ink droplets from ink nozzles in the printer's print head. However, some of these ink nozzles may malperform. That is, some ink nozzles may indeed eject ink droplets; however, the ink droplets are ejected along a trajectory deviating from the droplets' desired trajectory, thereby leading to artifacts in the printed image. Also, some ink nozzles may eject ink droplets having ink droplet volumes either less than or greater than the desired ink droplet volume. In addition, some ink nozzles may eject ink droplets at an undesired velocity. Moreover, some ink nozzles may completely fail to eject any ink droplets at all. When such malperforming nozzles are present, undesirable lines and artifacts will appear in the printed image, thereby degrading image quality. Also, when nozzle failures occur, unprinted lines will appear in the printed image along the direction of print head movement, thereby greatly degrading image quality.

Malperforming and inoperative nozzles may be caused, for example, by blockage of the ink nozzle due to coagulation of solid particles in the ink fluid in the nozzle. Malperforming and inoperative nozzles may also be due to inadvertent presence of foreign particles in the ink or faulty nozzle holes in a nozzle plate attached to the ink nozzles. Yet another reason for malperforming and inoperative nozzles may be inability to activate the ink droplets when required. That is, ink nozzles may fail to eject ink droplets as desired due to failures in an electric drive circuit which activates the nozzles in order to eject ink droplets. Moreover, ink nozzle malperformance due to failures in the electric drive circuit may give rise to ink droplets not having either a desired volume and/or a desired velocity, which in turn produce image artifacts. Also, such malperforming nozzles may only malperform intermittently. That is, such malperforming nozzles may operate as desired for a time and then malperform for a time only to return to the nozzle's desired operation. Moreover, in the case of thermal ink jet print heads, resistive heater elements that are in heat transfer communication with the ink in the nozzles for ejecting ink droplets may become degraded by repeated on-off heating duty cycles. Such heater element degradation compromises ability of the heater elements to supply the desired amount of heat when activated. For example, if a degraded heater element supplies less that the desired amount of heat to the ink, then an ink droplet may not be ejected from its associated ink nozzle. Therefore, it would be desirable to unclog such malperforming or inoperative ink nozzles or otherwise enable such malperforming inoperative ink nozzles to produce quality images.

Techniques for purging clogged ink nozzles are known. For example, U.S. Pat. No. 4,489,335 discloses a detector that detects nozzles which fail to eject ink droplets. A nozzle purging operation then occurs when the clogged ink nozzles are detected. As another example, U.S. Pat. No. 5,455,608 discloses a sequence of nozzle clearing procedures of increasing intensity until the nozzles no longer fail to eject ink droplets. Similar nozzle clearing techniques are disclosed in U.S. Pat. No. 4,165,363 and U.S. Pat. No. 5,659,342.

However, the art referred to hereinabove appear directed to recovery procedures when a nozzle completely fails to eject an ink droplet. Thus, this art appears to ignore the case in which, although the purged nozzle ejects an ink droplet, the droplet nonetheless does not possess desired characteristics (e.g., desired trajectory, desired volume, etc.). Moreover, the art referred to hereinabove appear to ignore the case in which not all failed nozzles can be recovered to be functional merely by performing nozzle clearing operations (e.g., wiping, purging, extensive firing and the like). For example, solid coagulates in the ink blocking the ink nozzles may strongly resist removal by nozzle clearing operations. That is, if only some of the solid coagulates are removed, then an ink droplet will eject; however, the ejected ink droplet may not have the desired trajectory, desired volume, e.t.c. Moreover, such nozzle clearing operations, even if successful in removing solid coagulates, cannot repair failed resistive heaters or failed electric driver circuits. Of course, presence of such permanently malperforming or inoperative nozzles compromises image quality.

Therefore, there has been a long-felt need to provide an ink jet printer and method capable of compensating for malperforming and inoperative ink nozzles in a print head, so that quality images are printed although some ink nozzles are malperforming or inoperative.

### SUMMARY OF THE INVENTION

An object of the present invention is to provide an ink jet printer and method of compensating for malperforming and inoperative ink nozzles in a print head, so that quality images are printed although some ink nozzles are malperforming or inoperative.

With this object in view, the present invention resides in a printer comprising a plurality of drop-emitter nozzles arranged such that a first nozzle is adapted to print along a first path substantially the same as a second path previously printed by a second nozzle; and a control adapted to enable said first nozzle during a portion of the first path and to enable said second nozzle during a complementary portion of the first path, such that said first or said second nozzle is enabled during the entirety of the first path, said control being effective to disable said first or said second nozzle during the entirety of the first path to enable said first nozzle or said second nozzle during the entirety of the second path.

A feature of the present invention is the provision of an ink jet printer comprising a print head including operative ink nozzles that are capable of compensating for malperforming and inoperative ink nozzles.

An advantage of the present invention is that quality images are printed although some of the ink nozzles are malperforming or inoperative.

Another advantage of the present invention is that lifetime of the print head is increased and therefore printing costs are reduced.

These and other objects, features and advantages of the present invention will become apparent to those skilled in the art upon a reading of the following detailed description when taken in conjunction with the drawings wherein there is shown and described illustrative embodiments of the invention.

### BRIEF DESCRIPTION OF THE DRAWINGS

While the specification concludes with claims particularly pointing-out and distinctly claiming the subject matter of the present invention, it is believed the invention will be better understood from the following description when taken in conjunction with the accompanying drawings wherein:

FIG. 1 is a view in perspective of a printer with parts removed for clarity;

FIG. 2A illustrates a first mask pattern produced by an operative nozzle of the printer during a first printing pass;

FIG. 2B illustrates a second mask pattern produced by an operative nozzle of the printer during a second printing pass;

FIG. 3 illustrates a first algorithm for acquiring nozzle performance information (i.e., nozzles operative, malperforming or inoperative);

FIG. 4 is a plan view of the printer, with parts removed for clarity;

FIG. 5A illustrates a first mask pattern produced by an inoperative nozzle of the printer during a first printing pass;

FIG. 5B illustrates a second mask pattern produced by an operative nozzle of the printer during a second printing pass;

FIG. 5C illustrates a test image for detecting malperforming ink nozzles as well as fully operative ink nozzles; and

FIG. 6 illustrates a second algorithm providing image processing steps which result in compensating for malperforming or inoperative ink nozzles.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

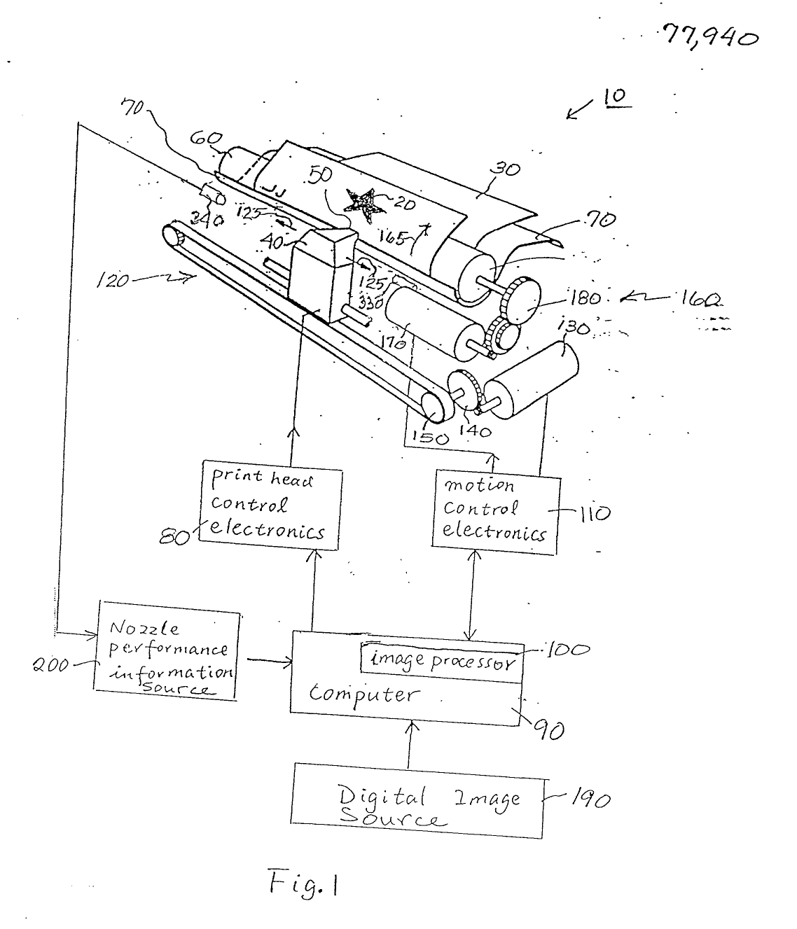

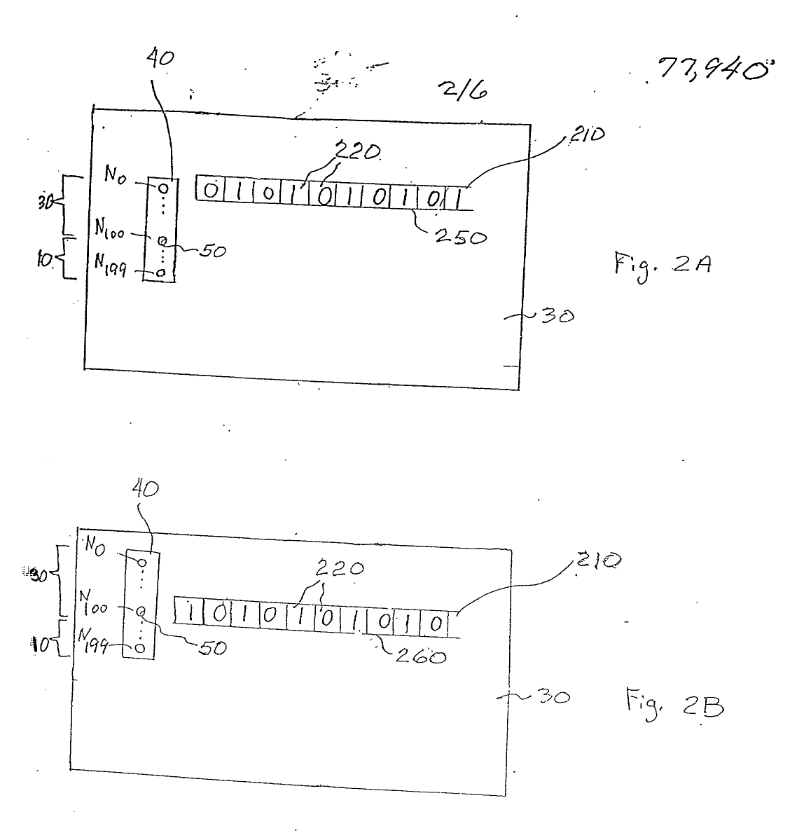

Therefore, referring to FIGS. 1, 2A and 2B, there is shown a printer, generally referred to as 10, for printing an output image 20 on a receiver 30, which may be a reflective-type receiver (e.g., paper) or a transmissive-type receiver (e.g., transparency). Printer 10 prints image 20 by means of a print head 40, which is an ink jet print head having a plurality of ink ejection nozzles 50 formed therein. For reasons disclosed hereinbelow, each nozzle 50 is assigned a unique index number “Nᵢ”, where i=0 . . . M. Here, the value “M” may be equal to the total number of nozzles 50 formed in print head 40. By way of example only and not by way of limitation, there may be 200 index numbers Nᵢ where i=0 to 199. That is, there may be 200 ink nozzles 50 in print head 40.

Referring again to FIGS. 1, 2A and 2B, it is seen that printer 10 generally comprises the following components: (a) a rotatable platen 60 and a receiver guide 70 for translating receiver 30 with respect to print head 40; (b) print head control electronics 80 connected to print head 40 for controlling activation of nozzles 50 in print head 40; (c) a computer 90 connected to print head control electronics 80 for providing image data to print head control electronics 80; (d) an image processor 100 coupled to computer 90 for processing the digital image data; (e) and motion control electronics 110 associated with print head 40 and platen 60 for controlling translation of print head 40 and rotation of platen 60. Each of these components in addition to other components defining the invention are described more fully hereinbelow.

Still referring to FIGS. 1, 2A and 2B, printer 10 further comprises a print head transport mechanism, generally referred to as 120. Print head transport mechanism 120 is coupled to print head 40 for reciprocating print head 40 with respect to receiver 30 along a direction illustrated by a double-headed arrow 125. In the preferred embodiment of the invention, print head transport mechanism 120 includes a first motor 130 engaging a gear 140, which in turn engages a pulley-belt assembly 150. Pulley-belt assembly 150 moves print head 40 with respect to receiver 30 along a fast scan direction as indicated by arrow 125 when first motor 130 operates. Although not shown, print head transport mechanism 120 may further include positional feedback, a linear encoder, and a direct current first motor 130. Alternatively, print head transport mechanism 120 may be a screw-driven arrangement having an elongate lead-screw (not shown) extending parallel to platen 60 and threadably engaging print head 40 for reciprocating print head 40 along a longitudinal axis of the lead-screw. Moreover, printer 10 also comprises a receiver transport mechanism, generally referred to as 160, for translating receiver 30 with respect to print head 40 along a direction illustrated by an arrow 165. In the preferred embodiment of the invention, receiver transport mechanism 160 includes a second motor 170 connected to motion control electronics 110 and engaging a gear arrangement 180. Second motor 170 operates platen 60 by means of gear arrangement 180, such that receiver 30 moves in the direction of arrow 165 and slides along guide 70 when second motor 170 operates.

Referring yet again to FIGS. 1, 2A and 2B, a digital image source 190 is connected to computer 90 for supplying an input digital image (not shown) to computer 90, which input digital image comprises a plurality of pixel values characterizing the digital image by pixel color, pixel location, e.t.c. In this regard, digital image source 190 may be a digital camera, scanner, or the like (also not shown). Alternatively, this input digital image also may be created on computer 90 by means of a suitable user interface that may include a display, a keyboard, a stylus, and/or a “mouse” (also not shown). Computer 90 preferably includes at least one communication port (not shown) for transferring image files and other information to external devices, such as a computer network mass storage area. A nozzle performance information source 200 is stored in a memory (not shown), which is connected to computer 90, for supplying information to computer 90 about performance of each nozzle 50. In this regard, the nozzle performance information supplied to computer 90 specifies whether each nozzle 50 is “malperforming”, “inoperative” or “fully operative”, as described in detail hereinbelow.

In addition, in ink jet printing, an image row is often printed in more than one printing pass for at least two reasons. First, risk of ink coalescence on the ink receiver is minimized because only a subset of all image pixels is printed in each printing pass. This also reduces probability that ink spots at adjacent pixels will be in liquid contact. Secondly, visual artifacts caused by variabilities between ink nozzles are reduced. Such variabilities may be due to variabilities introduced in manufacturing the print head. In order to ameliorate such variabilities, each image row is printed by more than one ink nozzle in more than one printing pass. Therefore, variability, such as errors in ink drop placement or ink drop volume, between ink nozzles 50 can therefore cancel each other and make image artifacts less apparent to the naked eye when more than one printing pass is made.

Therefore, FIGS. 2A and 2B illustrate printing of a single image row 210 in two passes when all nozzles 50 are fully operative. The terminology “fully operative” with respect to nozzles 50 is defined herein to mean nozzles 50 that eject ink drops having desired characteristics, such as desired ink drop trajectory, desired ink drop volume, and desired ink drop velocity. Entry values of mask patterns in image row 210 comprises a plurality of pixel locations 220 having pixel location index numbers Pᵢⱼ, where i=0 . . M and j=1 . . . C. In this exemplary embodiment of the invention, “M” is the total number of pixel rows that extend horizontally on receiver 30 and “C” is the total number of pixel columns that extend vertically on receiver 30. Thus, the subscript “i” for pixel location Pᵢⱼ denotes a row location and the subscript “j” for pixel location Pᵢⱼ denotes a column location. Therefore, location of each pixel in image 20 can be described by its two-dimensional pixel location number Pᵢⱼ. However, it should be noted that values of Pᵢⱼ are values for mask patterns in image rows 210 rather than pixel values obtained from the digital input image, as disclosed more fully hereinbelow. In order to determine whether a pixel is printed, the mask pattern value and the pixel value from the digital input image are logically multiplied (i.e., logically an “AND” arithmetic operation).

Referring to FIGS. 2A and 2B, it may be appreciated that a perfectly operating printer 10 has all nozzles 50 operative. The printing process begins when receiver transport mechanism 160 positions receiver 30 so that image row 210 comes into registration with nozzles N₀. Next, print head transport mechanism 120 translates print head 40 along the fast scan direction (i.e., direction of arrow 125) to print a swath plane comprising M image rows. More specifically, image row 210 is printed using a first mask pattern 250 corresponding to the first printing pass. For purposes of illustration, first mask pattern 250 for nozzle 50 is illustrated as containing entry values of “0's” and “1”, where the entry value of “1” is used herein to indicate that nozzle N₀ has been enabled to print a pixel at a predetermined pixel value at pixel location Pᵢⱼ and the entry value of “0” is used herein to indicate that nozzle N₀ has been disabled to not print a pixel location Pᵢⱼ.

Referring to FIG. 2B, receiver 30 is advanced by receiver transport mechanism 160 so that image row 210 comes into registration with nozzle N₁₀₀. At this point, the next swath plane of image 20 is printed. More specifically, image row 210 is printed using a second mask pattern 260. As described hereinabove, the values of “0's” and “1's” at pixel locations Pᵢⱼ in second mask pattern 260 represent enabling and disabling, respectfully, of printing at each pixel for that particular pass.

Referring again to FIGS. 2A and 2B, entry values in second mask pattern 260 are complementary to values in first mask pattern 250. That is, where an entry value of “0” appears in a column “j” of first mask pattern 250, such as at pixel location P_{0,1}, a complementary entry value of “1” appears in the same column “j” of second mask pattern 260, such as at pixel location P_{100, 1}. Conversely, where entry value of “1” appears in a column “j” of first mask pattern 250, such as pixel location P_{0, 2}, an entry value of “0” appears in the same column “j” of second mask pattern 260, such as at pixel location P_{100, 2}.

Referring yet again to FIGS. 2A and 2B, image row 210 is printed by nozzle 50 having index number N₀ in the first printing pass and then overprinted by nozzle 50 having index number N₁₀₀ in the second printing pass. In this manner, the combined effect of mask patterns 240 and 250 produced by the first and second printing passes, respectively, allows all pixels in image row 210 to be printed. Thus, during the first printing pass, nozzle N₀ is activated to print a predetermined portion of image row 210 using mask pattern 250. Similarly, during the second printing pass, nozzle N₁₀₀ is activated to print the remaining portion of image row 210 using mask pattern 260. In the present invention, nozzles that print over the same image rows, such as nozzles N₀ and N₁₀₀, are assigned to a nozzle group. Another nozzle group may include nozzles N₂ and N₁₀₂. Yet another nozzle group may include nozzles N₉₉ and N₁₉₉. It may be appreciated from the teachings herein that the present invention is compatible with other ways of organizing nozzle groups which may vary depending on the specific printing mode selected and may be different from the example disclosed immediately hereinabove. Such specific printing modes may, for example, be number of printing passes, paper transport amount after each pass, e.t.c.

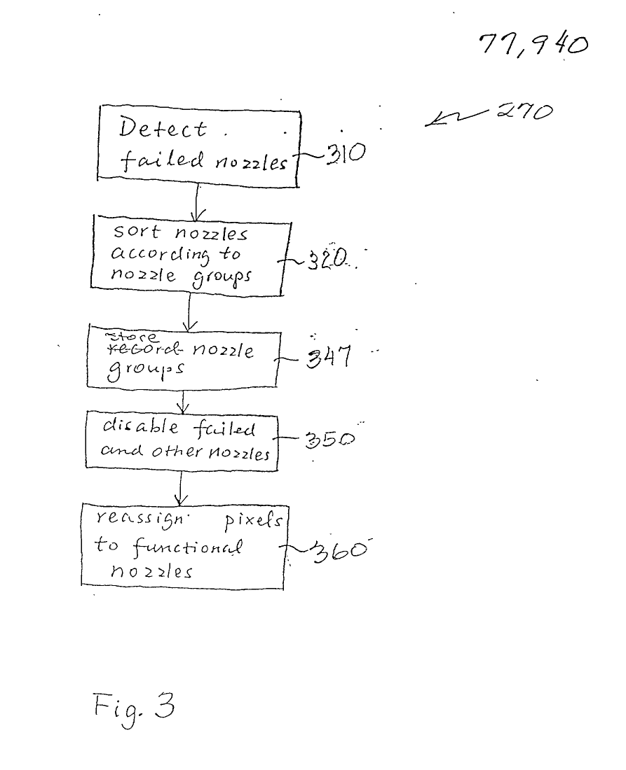

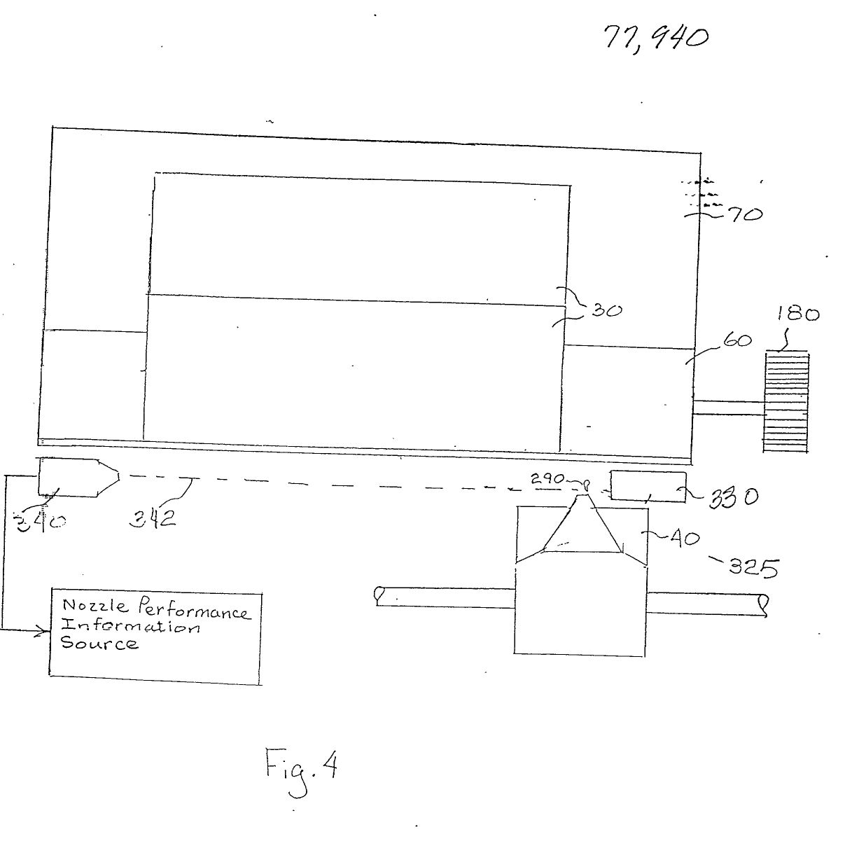

Referring to FIGS. 1, 2A and 2B, the input digital image is transmitted from digital image source 190 to computer 90 wherein the input digital image is processed by image processor 100. In this regard, image processor 100 is capable of resizing, cropping, tone scale transformation, color transformation, and/or halftoning the input digital image. Moreover, image processor 100 places the input digital image in a format useful for input to ink jet print head 40, which image format may be in the form of separate color planes comprising the input digital image (e.g., yellow, magenta, cyan and black color planes); or a plurality of swath planes that are each printed during different printing passes, as described hereinabove. As described more fully hereinbelow, image processor 100 also includes a first algorithm 270 (see FIG. 3) that acquires nozzle performance information such as whether nozzles 50 are either operative malperforming or inoperative. Also as described more fully hereinbelow, image processor 100 further includes a second algorithm 370 (see FIG. 6) for compensating for any inoperative nozzles 50. These algorithms 270 and 370 are used to acquire nozzle performance information and to compensate for presence of inoperative nozzles 50 by using only operative nozzles 50.

Referring yet again to FIGS. 1, 2A and 2B, the processed digital image data provided by image processor 100 is transmitted from image processor 100 to the previously mentioned print head control electronics 80. The print head control electronics 80 receives this processed digital image data and transforms this data into electrical signals that selectively drive (i.e., selectively activate) nozzles 50. These selectively driven nozzles 50 produce output image 20 on receiver 30 by printing a plurality of image rows 210 onto receiver 30. In addition, motion control electronics 110 controls first motor 130, so that print head 40 is controllably translated with respect to receiver 30 in order to print each image row 210 in first mask pattern 250. In addition, after each swath plane is printed, motion control electronics 110 controls second motor 170, such that platen 60 rotates to advance receiver 30 in a direction illustrated by arrow 165. Receiver 30 is advanced in this manner in order to prepare the ink nozzles in the same nozzle group for printing a different image mask pattern 260 on image row 210 of image 20. It may be appreciated from the description hereinabove that a single image row 210 belonging to image 20 may be completely printed in 3, 4, 6 or any number of such printing passes, if desired.

The description hereinabove was directed to the nominal case where all nozzles 50 are operative and no nozzles 50 are malperforming or inoperative. However, some of these nozzles 50 in fact may be malperforming or inoperative. It is desirable to detect and compensate for malperforming or inoperative nozzles 50 by activating fully operative nozzles 50, so as to provide high quality output image 20.

Referring to FIGS. 1, 2A, 2B and 3, first algorithm 270 for providing nozzle performance information begins with detecting inoperative nozzles 50, as at step 310 of first algorithm 270. The inoperative nozzles 50 are detected in a manner disclosed presently. Next, nozzles 50 are organized into nozzle groups, as at step 320, and as described hereinabove. Some of the index numbers Nᵢ are associated with malperforming and inoperative nozzles 50, while other ones of the index numbers Nᵢ are associated with fully operative nozzles 50. In step 347, these nozzle index numbers Nᵢ representing either malperforming, inoperative or operative nozzles 50 are stored as nozzle performance information in nozzle performance information source 200. This nozzle performance information is then transmitted from performance information source 200 to computer 90 where it is processed for use by image processor 100. It may be appreciated that nozzle performance information source 200 may be stored in an electronic memory connected to computer 90 for storing nozzle indices Nᵢ.

As best seen in FIGS. 3 and 4, any inoperative nozzles 50 are detected by an optical detection system, generally referred to as 325, comprising a light source 330 laterally disposed to one side of print head 40 and a light sensor 340 laterally disposed to an opposite side of print head 40. Light sensor 340 is coupled to nozzle performance information source 200 for transmitting an electrical signal to nozzle performance information source 200, as described in more detail presently. Light source 330, which may be a laser light source, is colinearly aligned with light sensor 340 and emits a light beam along a light beam path 342 passing adjacent to nozzles 50. Of course, light sensor 340, which may be a photodiode, receives light emitted by light source 330. Thus, in order to detect operative nozzles 50, motion control electronics 110 translates print head 40 to a position between light source 330 and light sensor 340, so that when an ink droplet 290 is ejected from operative nozzle 50, the light beam is interrupted. When the light beam is interrupted in this manner, an electrical signal produced by light sensor 340 causes this nozzle 50 to be recorded in nozzle performance information source 200 as an operative nozzle 50. On the other hand, if ink droplet 290 fails to eject from nozzle 50 when nozzle 50 is activated, then the light beam is uninterrupted and no electrical signal is produced by light sensor 340. In this latter case, nozzle 50 is recorded in nozzle performance information source 200 as an inoperative nozzle 50. Using this information, mask patterns 250 and 260 are applied to nozzle groups having all operative nozzles. Mask patterns 345 and 348 are subsequently applied to nozzle groups that include inoperative nozzles.

However, some nozzles 50 may be malperforming in the sense that ink droplets 290 are ejected but not as intended. Such nozzles are not completely “inoperative” and not “fully operative”. For example, some ink nozzles 50 may indeed eject ink droplets 290; however, the ink droplets 290 are ejected along a trajectory deviating from the droplets' desired trajectory; that is, the trajectory normal to a nozzle plate (not shown) belonging to printhead 40. Other ink nozzles may eject ink droplets 290 having ink droplet volumes either less than or greater than the desired ink droplet volume. Such ink nozzle behavior may lead to artifacts appearing in output image 20. That is, when such malperforming nozzles 50 are present, image artifacts, such as banding, will appear in the printed image, thereby degrading image quality. As described presently, the invention compensates for such malperforming nozzles 50, as well as for completely failed nozzles, in order to obtain a high quality output image 20.

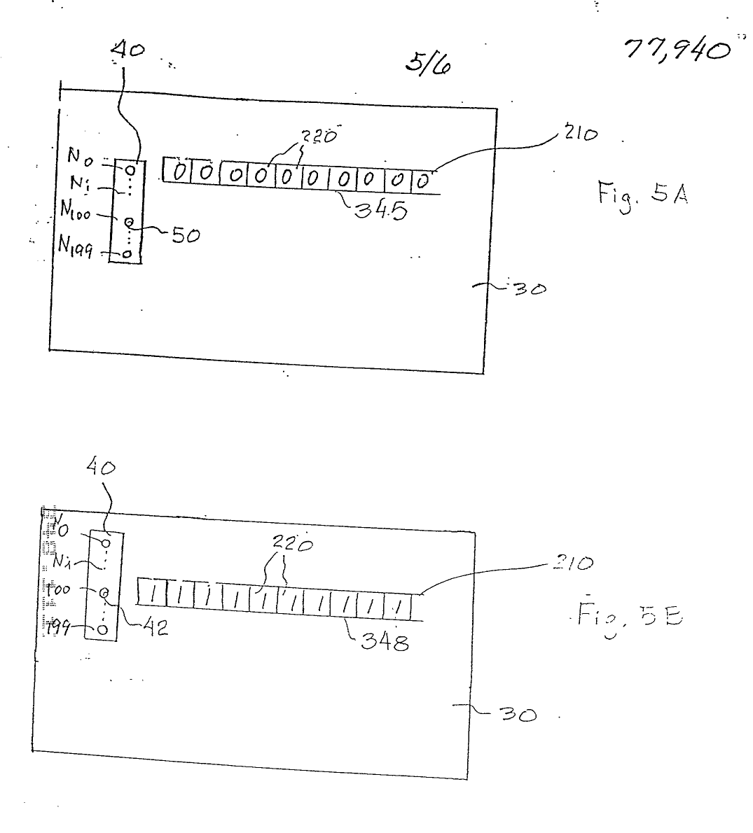

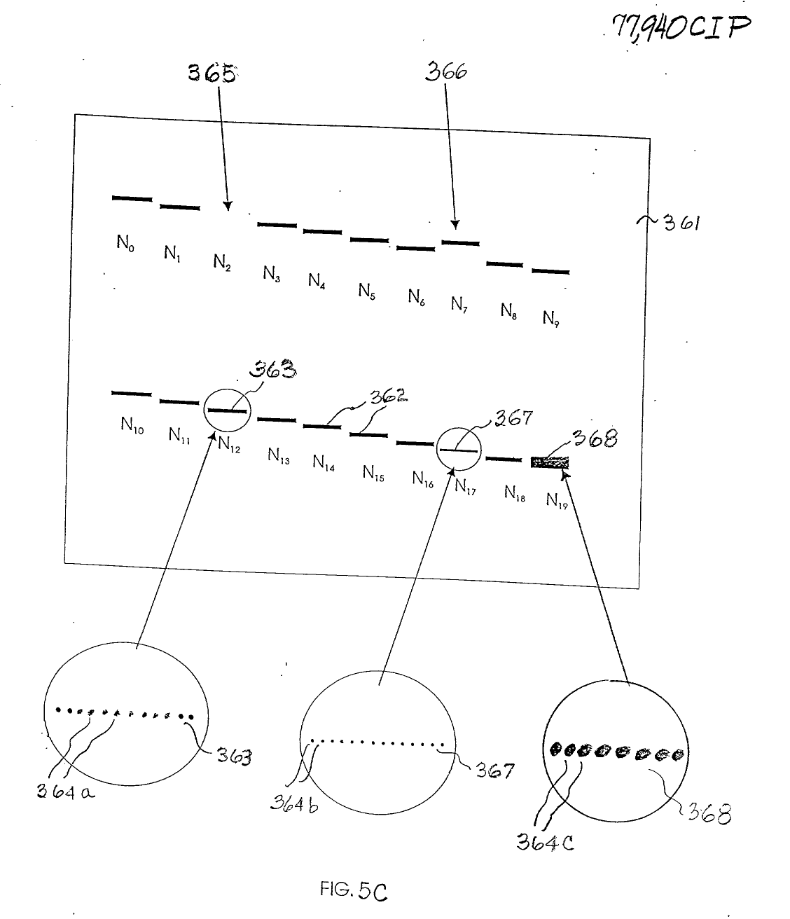

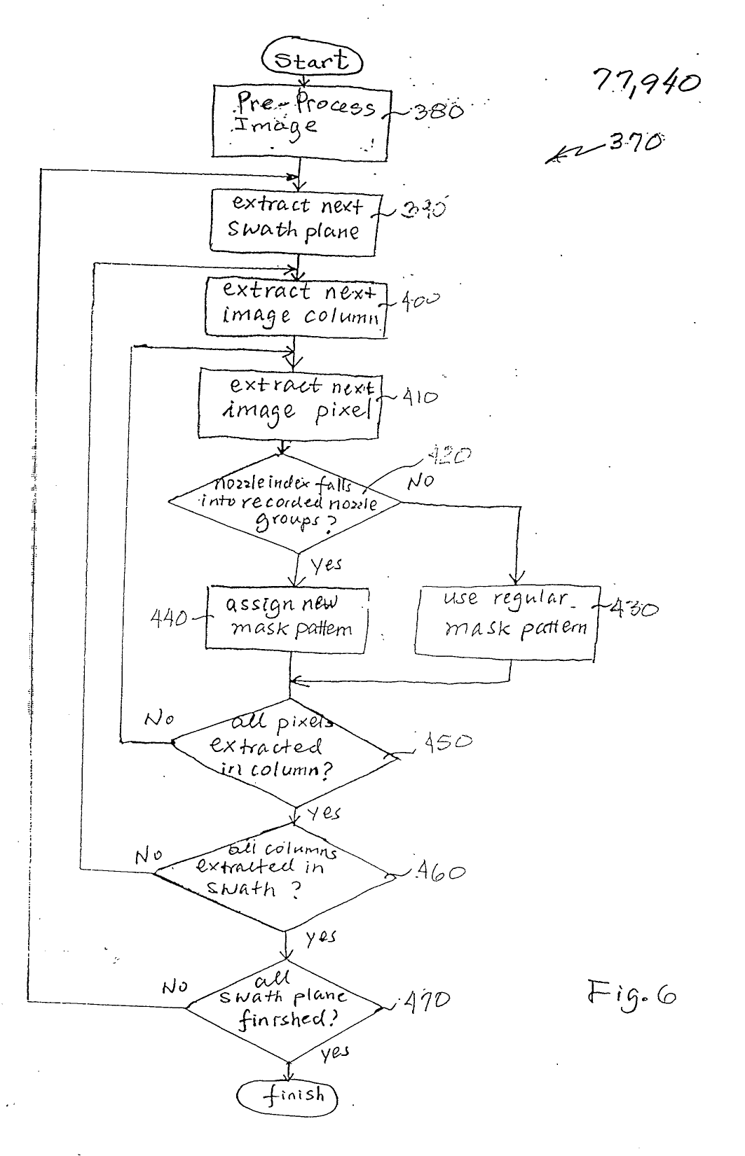

Therefore, as best seen in FIG. 5C, a test image 361 is first printed by a specific print head 40 for acquiring nozzle performance information. The purpose of printed test image 361 is to detect nozzles that are malperforming as well as nozzles that have completely failed. In this regard, printed test image 361 includes a plurality of ink marks, such as lines 362, with each line 362 being printed by a different nozzle Nᵢ, where i=0 to 199. For purposes of clarity, test printing results for only a subset of all two-hundred nozzles are shown in FIG. 5C. That is, test printing results only for nozzles Nᵢ, where i=0 to 19 are shown.

Still referring to FIG. 5C, a desired (i.e., perfectly formed) line 363 printed by a fully operative nozzle N₁₂ comprises a plurality of generally aligned ink dots 364a of substantially equal size, each ink dot 364a being formed by individual ink droplet 290. However, if any one of nozzles 50, such as nozzle N₂, completely fails to eject ink droplet 290, then a space 365 is observed where line desired 363 should be. In addition, if any one of nozzles 50, such as nozzle N₇, ejects ink droplet 290 along an undesired trajectory, then a line 366 is displaced from its intended location in printed test image 361. Moreover, if any one of nozzles 50, such as nozzle N₁₇, ejects an insufficient volume of ink for ink droplet 290, then a lighter and thinner than desired line 367 is produced. In this case, lighter than desired line 367 comprises ink dots 364b that are smaller than ink dots 364a. In addition, if any one of nozzles 50, such as nozzle N₁₉, ejects more than desired volume of ink for ink droplet 290, then a darker and thicker than desired line 368 is produced. In this case, darker than desired line 375 comprises ink dots 366c that are larger than ink dots 364a. The nozzle indices Nᵢ for fully operative, as well as malperforming nozzles, are stored in nozzle performance information source 200.

Referring again to FIG. 5, any malperforming nozzles 50 including any completely failed nozzles 50 can be detected visually or by means of automatically operated apparatus (not shown). With regard to visual detection, an operator of printer 10 examines nozzles 50 and determines the malperforming nozzles including the completely failed nozzles. Next, the operator nozzle index numbers Nᵢ corresponding to those nozzles ejecting ink droplets 290 in an undesirable manner as well as those nozzles that completely fail to eject ink droplets. The operator then inputs this information into computer 90, which stores the information in nozzle performance information source 200. On the other hand, with regard to detection by means of automatically operated apparatus, printed test image 361 is imaged by an image sensor (not shown), preferably integrally connected to printer 10. The image is then analyzed by at least one of a plurality of image pattern recognition programs well known in the art, to detect malperforming nozzles including completely failed nozzles. This information is then stored in nozzle performance information source 200. Such an automatic detection technique is disclosed in commonly assigned U.S. patent application Ser. No. 09/135,308 titled “Ink Jet Printing With Enhanced Image Stability” filed Aug. 17, 1998, the disclosure of which is hereby incorporated by reference.

Referring to FIGS. 4 and 6, it may be appreciated from the discussion hereinabove that previously mentioned light source 330 and light sensor 340 are used to detect completely failed nozzle 50. Also, it may be appreciated from the discussion hereinabove that test image 361 is also used to detect a completely failed nozzle 50, as well as detecting other malperforming nozzles 50. Therefore, if it is desired merely to detect completely failed nozzles 50, light source 330 and light sensor 340 may be used. Alternatively, test image 362 may be used to detect completely failed nozzles. An advantage of using light source 330 and light sensor 340 to detect a completely failed nozzle 50 is that test image 362 need not be printed. This results in a concomitant time savings because time spent printing and analyzing test image 362 is avoided.

FIGS. 5A and 5B provide an exemplary illustration of how such malperforming and inoperative nozzles 50 are compensated for by operative nozzles 50. In the example described presently, nozzle N₀ is assumed to be an inoperative (i.e., failed) nozzle. This nozzle N₀ will define a third mask pattern 345 in the first printing pass. In this regard, third mask pattern 345 defined by nozzle N₀ is illustrated as containing entry values of all “0's” (i.e., nozzle N₀ inoperative). On the other hand, nozzle N₁₀₀ is assumed to be an operative nozzle. This nozzle N₁₀₀ defines a fourth mask pattern 348 in the second printing pass. In this regard, fourth mask pattern 348 defined by nozzle N₁₀₀ is illustrated as containing entry values of all “l's” (i.e., nozzle N₁₀₀ operative). Thus, it may be understood that entry values appearing in fourth mask pattern 348 are complementary to entry values appearing in third mask pattern 345. That is, where entry value of “0” appears in column “j” for third mask pattern 345, a complementary entry value of “1” appears in the same column “j” for fourth mask pattern 348.

Referring again to FIGS. 5A and 5B, and as described hereinabove, third mask pattern 345 is illustrated as containing entry values of all “0's” (i.e., nozzle N₀ inoperative) and fourth mask pattern 348 is illustrated as containing entry values of all “1's” (i.e., nozzle N₁₀₀ operative). It may be appreciated from the description hereinabove that when the entry values in third mask pattern 345 are “0” for a specific inoperative nozzle 50, then no pixel locations P₀ⱼ (where j=1 . . . C) will be printed in the first printing pass regardless of the image value at those pixel locations. Similarly, it may be further appreciated from the description hereinabove, that if the entry values in fourth mask pattern 348 are “1” for a specific operative nozzle 50, then pixel locations P_{100, j} will be printed in the second printing pass consistent with the image values for those pixel locations. In this manner, all pixels for image row 210 are printed even though some nozzles 50 are inoperative. Also, the combined effect of fourth mask pattern 348 when overlaid onto third mask pattern 345, after completion of the first printing pass and second printing pass, allows all pixels in image row 210 to be printed using operative nozzles 50 in place of inoperative nozzles 50.

Referring to FIGS. 3, 5A and 5B, if nozzle N₀ is detected as inoperative in the manner disclosed hereinabove, then third mask pattern 345 for nozzle N₀ is stored in nozzle information source 200, as at step 347 of the previously mentioned first algorithm 270. Next, the inoperative nozzle 50 having index number N₀ is disabled, as at step 350 of first algorithm 270. This disabled nozzle 50 having index number N₀ is illustrated in FIG. 5A, wherein each entry value for each pixel location is “0”. These entry values of “0” indicate that no pixels in image row 210 are printed in the first printing pass. Put another way, the printing function of disabled nozzle 50 having index number N₀ (i.e., disabled nozzle 50 having entry values of “0”) are reassigned, as at step 360 of first algorithm 270, to operative nozzle 50 having index number N₁₀₀ (i.e., enabled nozzle 50 having entry values of “1”). That is, printing function of disabled nozzle N₀ is reassigned to operative nozzle N₁₀₀. Thus, entry values in image row 210 have a value of “1” during the second printing pass, so that all unprinted pixels associated with inoperative nozzle N₀ in the first printing pass are printed by operative nozzle N₁₀₀ in the second printing pass.

Turning now to FIG. 6, there is shown a second algorithm, generally referred to as 370. Second algorithm 370 illustrates imaging processing steps performed by image processor 100. In this regard, at step 380 the input image is operated upon in order to resize, crop, tone scale, halftone, transform color, and separate image row planes for each printing pass and each color. It may be appreciated that image processor 100 may perform other desired image preprocessing operations, as needed. As illustrated at step 390, a swath plane including a plurality of image rows 210, is extracted; that is, all pixel values of the swath plane are read by image processor 100. Next, an image column is extracted from the swath plane, as at step 400. An image pixel is then extracted from the image column “j” (where j=1 . . . C), as at step 410. In addition, step 420 determines whether nozzle 50 falls into a nozzle group containing inoperative nozzles. If all nozzles in a nozzle group are operative, nominal (i.e., regular) mask patterns are applied as shown in FIGS. 2A and 2B and at step 430. On the other hand, if nozzles 50 include inoperative nozzles, new mask patterns 345 and 348 are applied, as at step 440. At this point, steps 390 through 410 are repeated for all pixels Pᵢⱼ in steps 450 through 470. It should be observed that first algorithm 270 and second algorithm 370 preferably reside in computer 90 in machine language.

It is appreciated from the description hereinabove that an advantage of the present invention is that high quality images are printed although some ink nozzles are malperforming or inoperative. This is so because pixels that would otherwise be printed by inoperative ink nozzles 50 in a first printing pass are instead printed by operative ink nozzles 50 in a second printing pass.

Another advantage of the present invention is that printing costs are reduced. This is so because purchase of a new print head merely to replace malperforming and inoperative nozzles is virtually avoided.

While the invention has been described with particular reference to its preferred embodiments, it will be understood by those skilled in the art that various changes may be made and equivalents may be substituted for elements of the preferred embodiments without departing from the invention. For example, printer 10 may include a nozzle purging apparatus in communication with each nozzle 50. Such nozzle purging may be performed by an ink pump and a vacuum suction device. Thus, any malperforming or inoperative nozzles may be purged before using the invention to compensate for the inoperative nozzles. This technique has the advantage of restoring function of malperforming and inoperative nozzles, if possible, so that a minimum number of malperforming and inoperative nozzles need be compensated for by operative nozzles. In this manner, printing speed is not significantly reduced. Nonetheless, some of these malperforming and inoperative nozzles nonetheless may resist purging operations. According to this technique, compensating for such permanently malperforming and inoperative nozzles by using operative nozzles would only occur after any unsuccessful purging operations.

As is evident from the foregoing description, certain other aspects of the invention are not limited to the particular details of the examples illustrated, and it is therefore contemplated that other modifications and applications will occur to those skilled in the art. It is accordingly intended that the claims shall cover all such modifications and applications as do not depart from the true spirit and scope of the invention.

Therefore, what is provided is an ink jet printer and method of compensating for malperforming and inoperative ink nozzles in a print head, so that high quality images are printed although some ink nozzles are malperforming or inoperative.

What is claimed is:

1. An ink jet printer, comprising:
(a) a plurality of drop-emitter nozzles arranged such that a first nozzle is adapted to print along a first path substantially the same as a second path previously printed by a second nozzle; and
(b) a control adapted to enable said first nozzle during a portion of the first path and to enable said second nozzle during a complementary portion of the first path, such that said first or said second nozzle is enabled during the entirety of the first path, said control being effective to disable said first or said second nozzle during the entirety of the first path to enable said first nozzle or said second nozzle during the entirety of the second path.

2. A printer for printing an image on a receiver, comprising:
(a) a print head;
(b) a plurality of nozzles formed in said print head, a proportion of said nozzles being inoperative and a remaining proportion of said nozzles being operative;
(c) an optical detection system coupled to said nozzles for optically detecting said inoperative nozzles; and
(d) a computer connected to said nozzles for re-assigning printing function of said inoperative nozzles to said operative nozzles, so that said operative nozzles compensate for said inoperative nozzles in order that the image is printed on the receiver by the operative nozzles.

3. The printer of claim 2, further comprising a print head transport mechanism connected to said print head for translating said print head in a first direction with respect to the receiver, so that said print head prints on the receiver in the first direction.

4. The printer of claim 3, further comprising a receiver transport mechanism engaging said receiver for transporting said receiver in a second direction with respect to said print head, so that said print head prints on the receiver in the second direction orthogonal to the first direction.

5. A printer for printing a plurality of pixels forming a two-dimensional digital image on a receiver, each pixel being printed at a pixel location, comprising:
(a) an ink jet print head;
(b) a plurality of nozzles formed in said print head and segregated into a first nozzle group capable of printing predetermined ones of the pixels in a first printing pass and a second nozzle group capable of printing remaining ones of the pixels in a second printing pass, at least one of said nozzles in the first nozzle group being inoperative and at least another one of said nozzles in the second nozzle group being operative, said operative nozzle capable of ejecting an ink droplet;
(c) a light source disposed near said plurality of nozzles for emitting a light beam traveling along a predetermined light beam path extending adjacent said nozzles;
(d) a light sensor disposed near said plurality of nozzles and in the light beam path for receiving the light beam, said light sensor capable of generating an output signal as the ink droplet ejects from said operative nozzle and into the light beam path to interrupt the light beam, said light sensor failing to generate the output signal as the ink droplet fails to eject from said inoperative nozzle; and
(e) a computer connected to said light sensor for receiving the output signal generated thereby, said computer capable of detecting said inoperative nozzle by absence of the output signal and capable of detecting said operative nozzle by presence of the output signal, said computer capable of reassigning printing function of said inoperative nozzle in the first nozzle group to said operative nozzle in the second nozzle group, whereby said inoperative nozzle fails to print at the predetermined pixel location in the first printing pass, and whereby said operative nozzle prints in the second printing pass at the pixel location left unprinted by said inoperative nozzle.

6. The printer of claim 5, further comprising a print head transport mechanism connected to said print head for translating said print head horizontally with respect to the receiver, so that said print head prints on the receiver in a horizontal direction.

7. The printer of claim 5, further comprising a receiver transport mechanism engaging said receiver for transporting said receiver vertically with respect to said print head, so that said print head prints on the receiver in a vertical direction.

8. The printer of claim 5, wherein said computer is capable of electrically driving said nozzles to eject ink droplets therefrom.

9. The printer of claim 5, wherein said print head is formed of a piezoelectric material.

10. The printer of claim 5, wherein said print head is a plurality of print heads, each print head capable of ejecting ink droplets having a unique color.

11. A print head, comprising:
(a) a plurality of nozzles, at least one of said nozzles being inoperative and at least another one of said nozzles being operative; and
(b) a computer connected to said nozzles for re-assigning printing function of said inoperative nozzle to said operative nozzle.

12. The print head of claim 11, further comprising a detection system coupled to said nozzles for detecting said inoperative nozzle.

13. The print head of claim 12, wherein said detection system is an optical detection system.

14. A print head for printing an image on a receiver, comprising:
(a) a plurality of drop-emitter nozzles arranged such that a first nozzle is adapted to print along a first path substantially the same as a second path previously printed by a second nozzle; and
(b) a control adapted to enable said first nozzle during a portion of the first path and to enable said second nozzle during a complementary portion of the first path, such that said first or said second nozzle is enabled during the entirety of the first path, said control being effective to disable said first or said second nozzle during the entirety of the first path to enable said first nozzle or said second nozzle during the entirety of the second path.

15. The print head of claim 14, further comprising a first transport mechanism connected to said nozzles for translating said nozzles in a first direction with respect to the receiver, so that said nozzles print on the receiver in the first direction.

16. The print head of claim 15, further comprising a second transport mechanism engaging said receiver for transporting said receiver in a second direction orthogonal with respect to said nozzles, so that said nozzles print on the receiver in the second direction orthogonal to the first direction.

17. A method of assembling a printer, comprising the steps of:
(a) providing a plurality of drop-emitter nozzles arranged such that a first nozzle is adapted to print along a first path substantially the same as a second path previously printed by a second nozzle; and
(b) providing a control adapted to enable said first nozzle during a portion of the first path and to enable said second nozzle during a complementary portion of the first path, such that said first or said second nozzle is enabled during the entirety of the first path, said control being effective to disable said first or said second nozzle during the entirety of the first path to enable said first nozzle or said second nozzle during the entirety of the second path.

18. A method of assembling a printer for printing an image on a receiver, comprising the steps of:
(a) forming a plurality of nozzles in a print head, a proportion of the nozzles being inoperative and a remaining proportion of the nozzles being operative;
(b) coupling an optical detection system to the nozzles for optically detecting the inoperative nozzles; and
(c) connecting a computer to the detection system for re-assigning printing function of the inoperative nozzles to the operative nozzles, so that the operative nozzles compensate for the inoperative nozzles in order that the image is printed on the receiver by the operative nozzles.

19. The method of claim 18, further comprising the step of connecting a print head transport mechanism to the print head for translating the print head in a first direction with respect to the receiver, so that the print head prints on the receiver in the first direction.

20. The method of claim 19, further comprising the step of engaging a receiver transport mechanism with the receiver for transporting the receiver in a second direction orthogonal with respect to the print head, so that the print head prints on the receiver in the second direction orthogonal to the first direction.

21. A method of assembling a printer for printing a plurality of pixels forming a two-dimensional digital image on a receiver, each pixel being defined at a pixel location in the image, comprising the steps of:
(a) forming a plurality of nozzles in a print head and segregating the nozzles into a first nozzle group capable of printing predetermined ones of the pixels in a first printing pass and a second nozzle group capable of printing remaining ones of the pixels in a second printing pass, at least one of the nozzles in the first nozzle group being inoperative and at least another one of the nozzles in the second nozzle group being operative, the operative nozzle capable of ejecting an ink droplet;
(b) disposing a light source near the plurality of nozzles for emitting a light beam traveling along a predetermined light beam path extending adjacent the nozzles;
(c) disposing a light sensor near the plurality of nozzles and in the light beam path for receiving the light beam, the light sensor capable of generating an output signal as the ink droplet ejects from the operative nozzle and into the light beam path to interrupt the light beam, the light sensor failing to generate the output signal as the ink droplet fails to eject from the inoperative nozzle; and
(d) connecting a computer to the light sensor for receiving the output signal generated thereby, the computer capable of detecting the inoperative nozzle by absence of the output signal and capable of detecting the operative nozzle by presence of the output signal, the computer capable of re-assigning printing function of the inoperative nozzle to the operative nozzle, whereby as the inoperative nozzle fails to print at the predetermined pixel location in the first printing pass, the operative nozzle prints in the second printing pass at the pixel location left unprinted by the inoperative nozzle.

22. The method of claim 21, further comprising the step of connecting a print head transport mechanism to the print head for horizontally translating the print head with respect to the receiver, so that the print head prints on the receiver in a horizontal direction.

23. The method of claim 22, further comprising the step of engaging a receiver transport mechanism with the receiver for vertically transporting the receiver with respect to the print head, so that the print head prints on the receiver in a vertical direction.

24. The method of claim 21, wherein the step of connecting a computer comprises the step of connecting a computer capable of electrically driving the nozzles to eject ink droplets therefrom.

25. The method of claim 21, wherein the step of forming a plurality of nozzles in the print head comprises the step of forming the nozzles in a piezoelectric print head.

26. The method of claim 21, wherein the step of forming a plurality of nozzles in the print head comprises the step of forming the nozzles in a plurality of print heads, each print head capable of ejecting ink droplets having a unique color.

27. A method of assembling a print head, comprising the steps of:
(a) providing a plurality of drop-emitter nozzles arranged such that a first nozzle is adapted to print along a first path substantially the same as a second path previously printed by a second nozzle; and
(b) providing a control adapted to enable said first nozzle during a portion of the first path and to enable said second nozzle during a complementary portion of the first path, such that said first or said second nozzle is enabled during the entirety of the first path, said control being effective to disable said first or said second nozzle during the entirety of the first path to enable said first nozzle or said second nozzle during the entirety of the second path.

28. A method of assembling a print head for printing an image on a receiver, comprising the steps of:
(a) coupling an optical detection system to a plurality of nozzles for optically detecting inoperative nozzles, a proportion of the nozzles being inoperative and a remaining proportion of the nozzles being operative; and
(b) connecting a computer to the optical detection system for reassigning printing function of inoperative nozzles to the operative nozzles, so that the operative nozzles compensate for the inoperative nozzles in order that the image is printed on the receiver by the operative nozzles.

29. The method of claim 28, further comprising the step of connecting a first transport mechanism to the nozzles for translating the nozzles in a first direction with respect to the receiver, so that the nozzles print on the receiver in the first direction.

30. The method of claim 29, further comprising the step of engaging a second transport mechanism with the receiver for transporting the receiver in a second direction with respect to the nozzles, so that the nozzles print on the receiver in the second direction orthogonal to the first direction.
